(19) United States
(12) Patent Application Publication
(10) Pub. No.: US 2025/0254607 A1
(43) Pub. Date: Aug. 7, 2025

(54) INFORMATION PROCESSING APPARATUS, METHOD, AND STORAGE MEDIUM

(71) Applicant: CANON KABUSHIKI KAISHA, Tokyo (JP)

(72) Inventor: TOMOYUKI KAWANA, Kanagawa (JP)

(21) Appl. No.: 19/043,189

(22) Filed: Jan. 31, 2025

(30) Foreign Application Priority Data
Feb. 7, 2024 (JP) 2024-016992

(51) Int. Cl. H04W 48/16; H04W 48/14; H04W 84/12

(52) U.S. Cl. CPC H04W 48/16; H04W 48/14; H04W 84/12

(57) ABSTRACT

An information processing apparatus that communicates with an external apparatus includes searching for an external access point, obtaining information indicating whether the access point found by the search supports multi-link communication, and transmits information about the access point found by the search to the external apparatus, wherein the transmitted information includes the obtained information indicating whether the access point supports multi-link communication.

### BACKGROUND

### Field

The present disclosure relates to an information processing apparatus configured to communicate with an external apparatus, a method for the information processing apparatus, and a storage medium.

### Description of the Related Art

In recent years, wireless local area network (LAN) techniques have been applied to various apparatuses. Use of such wireless LAN techniques enables wireless connection of various apparatuses. Wirelessly connecting various apparatuses allows the apparatuses to be located in any place and eliminates the need for a cable or the like, unlike in a wired connection, thereby providing a user-friendly environment without cumbersomeness for a user. From this perspective, there is a tendency that a wireless LAN environment is established by setting an access point (AP) for wireless LAN not only at many homes, but also in office environments. A setting for a Service Set Identifier (SSID) for identifying an AP and a security setting for securing wireless communication can be made for the AP for wireless LAN. To connect a communication apparatus to an AP, not only a method of setting a wireless LAN connection through an operation unit of a communication apparatus, but also a method of setting a connection between the communication apparatus and the AP from another terminal apparatus different from the communication apparatus may be used. In this method, the terminal apparatus transmits connection setting information for connecting to the AP to the communication apparatus, and the communication apparatus connects to the AP using the transmitted connection setting information. Use of a method discussed in Japanese Patent Application Laid-Open No. 2020-22027 can minimize settings for wireless LAN connection on a communication apparatus and facilitate a user to make connection settings also for the communication apparatus including no sophisticated operation unit from a terminal apparatus such as a smartphone.

As wireless LAN techniques, the Institute of Electrical and Electronics Engineers (IEEE) 802.11b/11g/11n/11ac/11ax standards are known. In addition to these standards, a task group called IEEE 802.11be has been recently launched as a succeeding standard aiming at further improvement of throughput, improvement of frequency utilization efficiency, and improvement of communication latency. In the IEEE 802.11be standard, multi-link communication in which, for example, one AP establishes a plurality of links with one station (STA) via a plurality of frequency channels and performs communication in parallel has been discussed. In the case of using an AP that supports multi-link communication, the establishment of multi-link communication in an environment with excellent communication quality makes it possible to improve the communication throughput as compared with communication via a single frequency channel.

In the method of related art in which a setting for a connection between a communication apparatus and an access point is made from a terminal apparatus, the communication apparatus cannot be connected to a suitable access point in some cases.

### SUMMARY

The present disclosure is directed to providing a method that enables a communication apparatus to be connected to a suitable access point.

According to an aspect of the present disclosure, an information processing apparatus configured to communicate with an external apparatus includes a memory storing a program and a processor, that when executing the program, causes the information processing apparatus to search for an external access point and to obtain information indicating whether the access point found by the search supports multi-link communication, and a transmission unit configured to transmit information about the access point found by the search to the external apparatus, wherein the transmitted information includes the obtained information indicating whether the access point supports multi-link communication.

Further features of the present disclosure will become apparent from the following description of exemplary embodiments with reference to the attached drawings.

### BRIEF DESCRIPTION OF THE DRAWINGS

FIG. 1 illustrates a configuration example of a system according to a first exemplary embodiment.

FIG. 2A is a perspective view illustrating an external configuration example of a multi-function peripheral (MFP), and FIG. 2B is a block diagram illustrating an internal configuration of the MFP.

FIGS. 3A to 3C each illustrate an example of an operation display unit of the MFP.

FIGS. 4A to 4E each illustrate a method for setting a multi-link communication function of the MFP.

FIG. 5A is an external view illustrating a configuration example of an information processing apparatus, and FIG. 5B is a block diagram illustrating an internal configuration of the information processing apparatus.

FIG. 6 is a flowchart illustrating processing to be performed by the information processing apparatus and the MFP.

FIG. 7 illustrates a screen transition during wireless connection.

FIGS. 8A to 8C are tables each illustrating access point (AP) attribute information about an AP group.

FIG. 9 is a flowchart illustrating a flow of display control processing according to the first exemplary embodiment.

FIGS. 10A to 10C each illustrate array data to be handled in display control processing according to the first exemplary embodiment.

FIGS. 11A and 11B each illustrate an AP selection screen on which an AP search result is displayed on the information processing apparatus.

FIG. 12 is a correspondence table illustrating icons to be displayed and radio wave quality ranks.

FIG. 13 is a flowchart illustrating a flow of display control processing according to the first exemplary embodiment.

FIG. 14 is a flowchart illustrating a flow of display control processing according to the first exemplary embodiment.

FIG. 15 is a flowchart illustrating processing to be performed by the information processing apparatus and the MFP according to a second exemplary embodiment.

FIGS. 16A and 16B each illustrate an AP selection screen for the information processing apparatus according to a third exemplary embodiment.

FIG. 17 is a flowchart illustrating a flow of display control processing according to the third exemplary embodiment.

### DESCRIPTION OF THE EMBODIMENTS

Exemplary embodiments of the present disclosure will be described in detail with reference to the drawings. The following exemplary embodiments are merely examples, and specific examples of components, processing steps, display screens, and the like are not intended to limit the scope of the present disclosure unless otherwise specifically noted.

### System Configuration

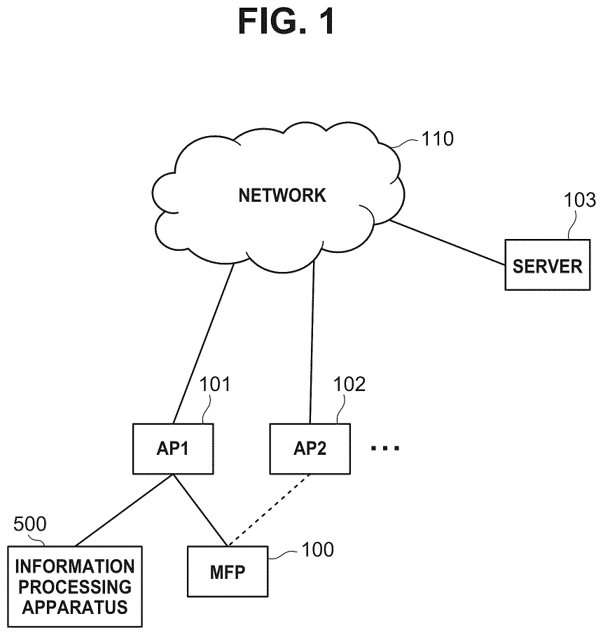

A first exemplary embodiment will now be described. FIG. 1 illustrates a configuration example of a system according to the first exemplary embodiment. This system is, for example, a wireless communication system in which a plurality of communication apparatuses can wirelessly communicate with each other. The system illustrated in FIG. 1 includes, as communication apparatuses, an information processing apparatus 500, a multi-function peripheral (MFP) 100, an access point (AP) 1 (101), an AP 2 (102), a server 103, and a network 110. The information processing apparatus 500 is an example of an external apparatus and includes a wireless communication function using a wireless local area network (LAN) or the like. A wireless LAN is hereinafter also referred to as WLAN. The information processing apparatus 500 may be a personal information terminal, such as a personal digital assistant (PDA), a mobile phone (smartphone), a digital camera, a personal computer (PC), or the like.

The MFP 100 is an example of an information processing apparatus, and is a printing apparatus including a printing function. The MFP 100 may further include a scanning function (scanner), a facsimile (FAX) function, and a telephone function. The MFP 100 according to the first exemplary embodiment includes a communication function for establishing wireless communication with the information processing apparatus 500. While the first exemplary embodiment illustrates an example where the MFP 100 is used, the present exemplary embodiment is not limited to this example. For example, a scanner apparatus, a projector, a mobile terminal, a smartphone, a laptop PC, a tablet terminal, a PDA, a digital camera, a music playback device, a television set, or a smart speaker, each of which includes the communication function, may be used instead of the MFP 100.

The AP 1 (101) is provided separately from (external to) the information processing apparatus 500 and the MFP 100, and operates as a station apparatus for WLAN. A communication apparatus including a WLAN communication function can establish communication in a WLAN infrastructure mode via the AP 1 (101). An access point is hereinafter also referred to as an “AP”. The infrastructure mode is also referred to as a “wireless infrastructure mode”. The AP 1 (101) establishes wireless communication with a communication apparatus allowed (authenticated) to connect to the communication apparatus, and relays wireless communication between the communication apparatus and another communication apparatus. An apparatus to be connected to the AP is referred to as a station (STA). The AP 1 (101) may be connected to, for example, a wired communication network and may relay communication between a communication apparatus connected to the wired communication network and another communication apparatus wirelessly connected to the AP 1 (101).

The AP 2 (102) indicates an AP that is different from the AP 1 (101). Like the AP 1, the AP 2 is located within a range in which the AP 2 can establish wireless communication with the MFP 100. A user operation enables the MFP 100 to switch the connection from the AP 1 (101) to the AP 2 (102). Access points other than the AP 1 (101) and the AP 2 (102) may also be present.

The server 103 is connected to the MFP 100 via the AP 1 (101) or the AP 2 (102) and the network 110, and provides services to the MFP 100 in response to a request from the MFP 100. The network 110 may be the so-called Internet, a closed network within an organization, or a mobile telephone network.

### External Configuration of MFP

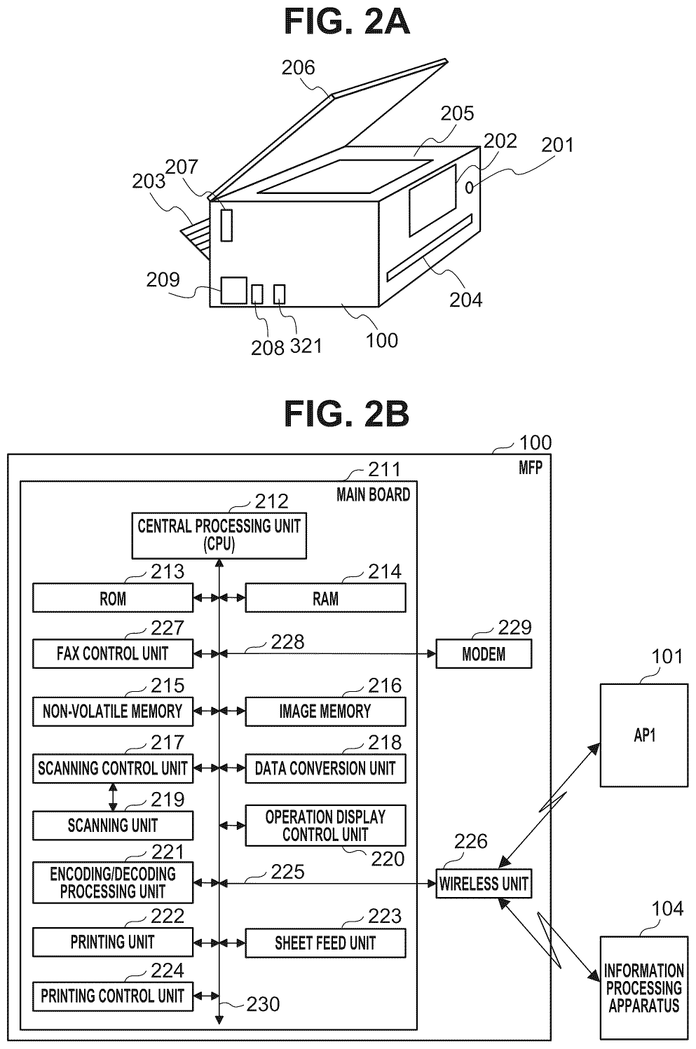

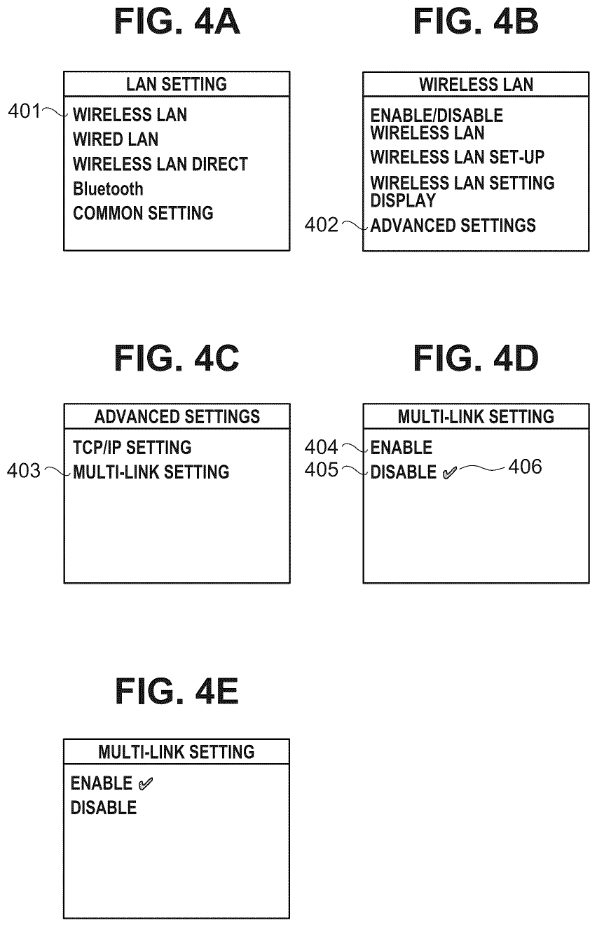

FIG. 2A illustrates an external configuration example of the MFP 100. The MFP 100 includes an operation display unit (operation panel) 202, a print sheet insertion opening 203, a print sheet discharge opening 204, a platen glass 205, and a platen glass pressure plate 206. A housing of the MFP 100 is provided with a hardware key for turning on or off a power supply as a power button 201. The operation display unit 202 includes a display and buttons for operating the MFP 100. For example, the operation display unit 202 includes a plurality of keys, including character input keys, cursor keys, an enter key, and a cancel key, and a light source such as a light-emitting diode (LED) or a liquid crystal display (LCD). The operation display unit 202 is configured to receive an operation input from a user to, for example, change various settings upon start-up of each function included in the MFP 100. Typically, a touch panel display is used as the operation display unit 202 (see FIGS. 4A to 4E).

The print sheet insertion opening 203 is an insertion opening for setting sheets of any size. Sheets set on the print sheet insertion opening 203 are conveyed one by one to a printing unit and are printed. Printed sheets are discharged from the print sheet discharge opening 204. The platen glass 205 is a glass-like transparent plate and is used to scan an image of a document placed on the platen glass 205 using the scanning function. The platen glass pressure plate 206 is a cover for pressing a document against the platen glass 205 to prevent the document from moving upward away from the platen glass 205 during scanning of the image using the scanning function, and also functions to shield external light from entering into a main body of the MFP 100.

The MFP 100 includes the communication function using WLAN or wired LAN. In the first exemplary embodiment, the MFP 100 includes not only an antenna for establishing wireless communication, but also a communication unit 321 for establishing a wired LAN. The MFP 100 also includes a universal serial bus (USB) communication unit 209 configured to establish communication with an external apparatus such as the information processing apparatus 500 via a USB connection.

### Internal Configuration of MFP

FIG. 2B illustrates an internal configuration example of the MFP 100. The MFP 100 includes a main board 211 for performing main control processing on the MFP 100, and a wireless unit 226 as a communication module for establishing WLAN communication using at least one common antenna. The MFP 100 includes, for example, a modem 229 for establishing wired communication. The main board 211 includes, for example, a central processing unit (CPU) 212, a read-only memory (ROM) 213, a random access memory (RAM) 214, a non-volatile memory 215, an image memory 216, a scanning control unit 217, a data conversion unit 218, a scanning unit 219, and an encoding/decoding processing unit 221. The main board 211 includes, for example, a printing unit 222, a sheet feed unit 223, a printing control unit 224, and an operation display control unit 220. These functional units in the main board 211 are interconnected via a system bus 230 that is controlled by the CPU 212. The main board 211 and the wireless unit 226 are connected via, for example, a dedicated bus 225, and the main board 211 and the modem 229 are connected via, for example, a bus 228.

The CPU 212 is a system control unit including at least one processor, and controls an overall operation of the MFP 100. Processing to be performed by the MFP 100 as described below is implemented such that, for example, the CPU 212 executes programs stored in the ROM 213. Dedicated hardware for each processing may be prepared. The ROM 213 stores control programs to be executed by the CPU 212, an embedded operating system (OS) program, and the like. In the first exemplary embodiment, the CPU 212 executes control programs stored in the ROM 213 under the embedded OS, which is also stored in the ROM 213, thereby performing software control processing such as scheduling and task switch.

The RAM 214 is composed of a static RAM (SRAM). The RAM 214 stores data such as program control variables, setting values registered by the user, and control data for the MFP 100. The RAM 214 may be used as various work buffers. The non-volatile memory 215 is composed of a memory such as a flash memory, and continuously stores data even after the MFP 100 is powered off. The image memory 216 is composed of a memory such as a dynamic RAM (DRAM). The image memory 216 accumulates image data received via the wireless unit 226, image data processed by the encoding/decoding processing unit 221, and the like. The memory configuration of the MFP 100 is not limited to the above-described configuration. The data conversion unit 218 performs processing of, for example, analyzing data of various formats and converting image data into print data.

The scanning control unit 217 controls the scanning unit 219 (e.g., a contact image sensor (CIS)) to optically scan a document placed on the platen glass 205. The scanning control unit 217 converts an image obtained by optically scanning the document into electrical image data (image signal), and outputs the image data. In this case, the scanning control unit 217 may output the image data after performing various image processing, such as binarization processing and halftone processing, on the image data.

The operation display control unit 220 corresponds to the operation display unit 202 described above with reference to FIG. 2A, and executes processing of, for example, displaying information based on display control by the CPU 212 on a display, and generating a signal upon reception of a user operation.

The encoding/decoding processing unit 221 performs encoding processing, decoding processing, and scaling processing on image data (Joint Photographic Experts Group (JPEG) data, Portable Network Graphics (PNG) data, etc.) to be handled by the MFP 100.

The sheet feed unit 223 holds sheets for printing. The sheet feed unit 223 is configured to supply set sheets under the control of the printing control unit 224. The sheet feed unit 223 may include a plurality of sheet feed units to hold various types of sheets in a single apparatus, and may control feeding of sheets from one of the sheet feed units under the control of the printing control unit 224.

The printing control unit 224 performs various image processing, such as smoothing processing, print density correction processing, and color correction, on image data to be printed, and outputs the processed image data to the printing unit 222. The printing unit 222 is configured to execute, for example, inkjet printing processing, and causes a printhead to eject ink supplied from an ink tank, thereby recording an image on a recording medium such as a sheet. The printing unit 222 may be configured to execute any other printing processing such as electrophotographic printing processing. The printing control unit 224 may periodically read out information about the printing unit 222, and may update status information and the like that are stored in the RAM 214 and include the remaining amount of ink in each ink tank and a printhead state.

The wireless unit 226 is a unit configured to provide the WLAN communication function, and can provide, for example, a function similar to a combination of the WLAN communication function with a function of a WLAN unit 401 of the information processing apparatus 500. Specifically, the wireless unit 226 converts data into packets based on the WLAN standard, transmits the packets to another external device, restores the packets from the other external device into original data, and outputs the data to the CPU 212. The wireless unit 226 is configured to establish communication as a station compliant with the Institute of Electrical and Electronics Engineers (IEEE) 802.11 standard series. In particular, the wireless unit 226 is configured to establish communication as a station compliant with the IEEE 802.11a/b/g/n/ac/ax/be standards. A station is hereinafter also referred to as a STA. The MFP 100 supports the IEEE 802.11be, or Wi-Fi®7, and is configured to establish communication as the STA that supports multi-link communication.

The information processing apparatus 500 and the MFP 100 are configured to establish peer-to-peer (P2P) (WLAN) communication or the like based on Wi-Fi® Direct (WFD) standard, and the wireless unit 226 includes a software access point (software AP) function or a group owner function. Specifically, the wireless unit 226 is configured to construct a P2P communication network and determine a channel to be used for P2P communication. Thus, the information processing apparatus 500 and the MFP 100 are configured to establish direct communication without involving any external access point using Wi-Fi® Direct. The information processing apparatus 500 and the MFP 100 may also establish direct communication with a partner apparatus while the information processing apparatus 500 and the MFP 100 operate as APs (software AP mode).

### Operation Display Unit of MFP

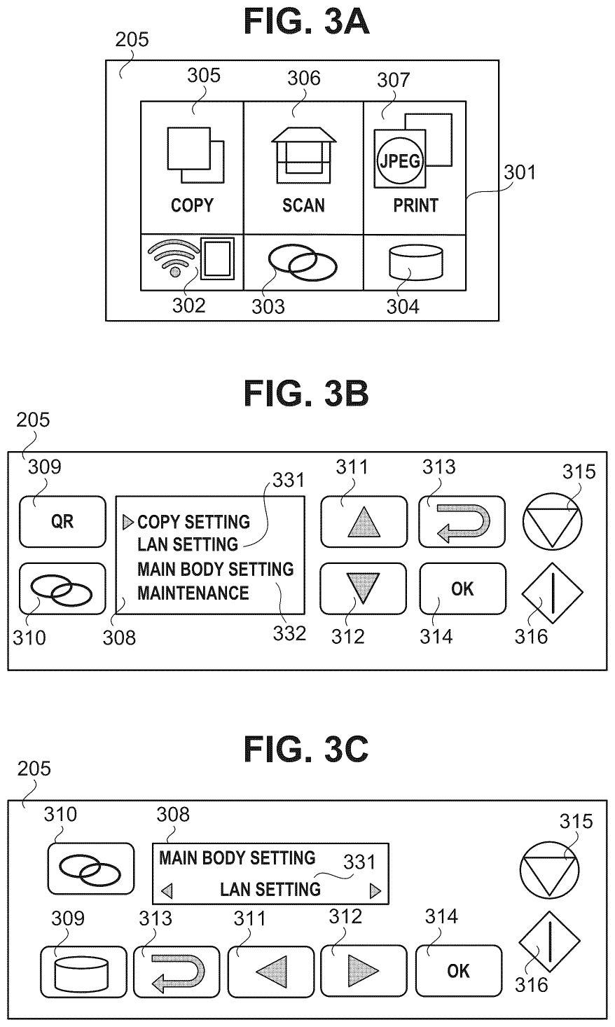

FIGS. 3A to 3C illustrate a configuration example of the operation display unit 202 of the MFP 100. FIG. 3A illustrates an example where a touch panel display 301 is employed as the operation display unit 202.

The user can start the MFP 100 by selecting the power button 201. When the MFP 100 is started, a home screen (typically, an uppermost layer of a menu) is displayed as a screen that can be operated by the user on the touch panel display 301.

The home screen includes a copy area 305, a scan area 306, and a print area 307. The copy area 305 enables providing a copy processing execution instruction. The scan area 306 enables providing a scan processing execution instruction. The print area 307 enables providing a printing processing execution instruction.

The home screen may further include a state display area 302, a connection setting mode area 303, and a setting area 304. The state display area 302 indicates a setting for infrastructure connection, direct connection, and the like, and a connection state of the MFP 100. An operation on the connection setting mode area 303 enables the user to start an operation in a connection setting mode at any time. The user can change various settings using the setting area 304.

FIG. 3B illustrates an example where a relatively small LCD display 308 and various hardware keys 309 to 316 are employed as the operation display unit 202.

When the MFP 100 is started, the home screen is displayed on the LCD display 308.

The user selects the cursor movement buttons 311 and 312 to operate a cursor displayed on the LCD display 308. The user may select the OK button 314 to execute the operation, or may select the back button 313 to return to the previous menu screen. A quick response (QR®) code including required information to establish a direct connection with the MFP 100 may be displayed by selecting the QR® button 309. The code to be displayed is not limited to a QR® code, and can be any two-dimensional code. When the QR® code is scanned from the information processing apparatus 500, the information processing apparatus 500 and the MFP 100 can be directly connected to each other and establish wireless communication. Selecting the connection setting mode button 310 makes it possible to start the connection setting mode. Transmission of connection information to the MFP 100 using the information processing apparatus 500 enables the MFP 100 to be connected to an AP 700. If the stop button 315 is selected while various processing operations are being executed by the MFP 100, various processing operations are cancelled. If the user selects the copy start button 316, the MFP 100 can also scan a document and execute printing.

As illustrated in FIG. 3C, a layout illustrated in FIG. 3B may be changed, as needed, and a cursor operation may be performed, for example, in a left-right direction. The above-described operation elements 308 to 316 may be implemented as display items, such as buttons, on a display screen, and the LCD display 308 may also be referred to as, for example, the screen 308.

### Method for Setting Multi-link Communication Function of MFP

FIGS. 4A to 4E each illustrate a method for setting a multi-link communication function of the MFP 100.

An AP and a STA establish a link via a plurality of frequency channels, and execute multi-link communication. Multi-link communication is defined in the IEEE 802.11 standard. The AP that executes multi-link communication is also referred to as an AP multi-link device (MLD). In the IEEE 802.11 standard series, a bandwidth of each frequency channel is defined as 20 MHz. The frequency channels are frequency channels defined in the IEEE 802.11 standard series. In the IEEE 802.11 standard series, a plurality of frequency channels is defined for each of frequency bands of 2.4 GHz band, 5 GHZ band, 6 GHz band, and 60 GHz band. A bandwidth of 40 MHz or more may be used in one frequency channel by bonding the adjacent frequency channels. For example, the AP 101 establishes a link with the STA via a first frequency channel of 5 GHz band, thereby making it possible to communicate with the STA. The STA establishes a link with the AP 101 via a second frequency channel of 6 GHz band in parallel with the link via the first frequency channel, thereby making it possible to communicate with the AP 101. In this case, the STA executes multi-link communication to maintain a second link via the second frequency channel in parallel with the link via the first frequency channel.

In the related art, the STA that supports the IEEE 802.11 standard is connected to an access point to establish data communication with the access point via a single link. A configuration for connecting to an access point to establish data communication via two or more links simultaneously by multi-link communication improves throughput. The IEEE 802.11be standard has discussed the support of 6 GHz band to enlarge the available frequency band. As the two or more links, two or more bands may be selected from the same frequency bands (any of sub-GHz band, 2.4 GHz band, 3.6 GHz band, 4.9 and 5 GHz bands, 60 GHz band, and 6 GHz band), or may be selected from different frequency bands. The AP that supports multi-link communication is referred to as an AP MLD, and the STA that supports multi-link communication is referred to as an STA MLD. APs that are associated with the AP MLD and operate on different channels are referred to as affiliated APs. STAs that are associated with the STA MLD and operate on different channels are referred to as affiliated STAs. Affiliated APs are each specified by adding a number after each AP and are expressed as, for example, AP 1, AP 2, . . . . Affiliated STAs are each specified by adding a number after each STA and are expressed as, for example, STA 1, STA 2, . . . . Thus, the AP 101 establishes a link with the STA via a plurality of frequency channels, thereby improving throughput in communication with the STA. A plurality of links in different frequency bands may be established between communication apparatuses in multi-link communication. For example, the AP 101 and the STA may establish a third link in 2.4 GHz band, in addition to the link in 5 GHz band and the link in 6 GHz band. Alternatively, the AP 101 and the STA may establish a link via a plurality of channels included in the same frequency band. For example, the AP 101 and the STA may establish not only the first link of 15 ch in 6 GHz band, but also the second link of 207 ch in 6 GHz band. Links in the same frequency band and links in different frequency bands may coexist. For example, the AP 101 and the STA may establish not only the link of 36 ch in 5 GHz band, but also the link of 149 ch in 5 GHZ band and the link of 15 ch in 6 GHz band. The AP 101 establishes a plurality of connections in different frequencies with the STA, thereby making it possible to establish communication with the STA in another bandwidth even if a given bandwidth is congested. This configuration prevents a deterioration in throughput and a communication delay in communication with the STA.

FIG. 4A illustrates a LAN setting screen to be displayed when, for example, a “LAN setting” 331 is selected on a menu screen illustrated in FIG. 3B. On the LAN setting screen, menu items, including “wireless LAN”, “wired LAN”, “wireless LAN direct”, “Bluetooth®”, and “common setting”, are displayed. FIG. 4B illustrates a wireless LAN setting screen to be displayed when the “wireless LAN 401” is selected on a menu screen illustrated in FIG. 4A. On the wireless LAN setting screen, menu items, including “enable/disable wireless LAN”, “wireless LAN set-up”, “wireless LAN setting display”, and “advanced settings” (402), are displayed. If the “advanced settings” (402) is selected, a screen illustrated in FIG. 4C is displayed.

FIG. 4C illustrates an advanced settings screen for wireless LAN. On the advanced settings screen for wireless LAN, menu items, including “Transmission Control Protocol (TCP)/Internet Protocol (IP) setting” and “multi-link setting” (403), are displayed. When the “multi-link setting” (403) is selected, a screen illustrated in FIG. 4D is displayed.

FIG. 4D illustrates a multi-link setting screen. On the multi-link setting screen, “enable” (404) and “disable” (405) are displayed as options. Selecting one of the options enables switching between “enable” and “disable” of the multi-link communication function of the MFP 100. The enable/disable setting in the multi-link communication function is stored in the non-volatile memory 215. When the screen illustrated in FIG. 4D is displayed, the operation display control unit 220 reads out this setting value from the non-volatile memory 215, and displays a check mark 406 for the current setting value. FIG. 4D illustrates an example where the check mark 406 indicates that the multi-link communication function is currently disabled. When the “enable” (404) is selected, the screen state is switched to a screen state illustrated in FIG. 4E, and the operation display control unit 220 stores “enable” for the multi-link setting value in the non-volatile memory 215.

When the multi-link setting is enabled, the MFP 100 behaves as a multi-link-supported STA. If the MFP 100 establishes a link with a multi-link-supported AP in a multi-link mode in this state, the MFP 100 can establish multi-link communication. If the MFP 100 establishes a link with the multi-link-supported AP in a non-multi-link mode, the MFP 100 perform communication via a single frequency channel. When the multi-link setting is disabled, the MFP 100 behaves as a multi-link-not-supported STA, and establishes a connection even with the multi-link-supported AP via a single frequency channel.

### External Configuration of Information Processing Apparatus

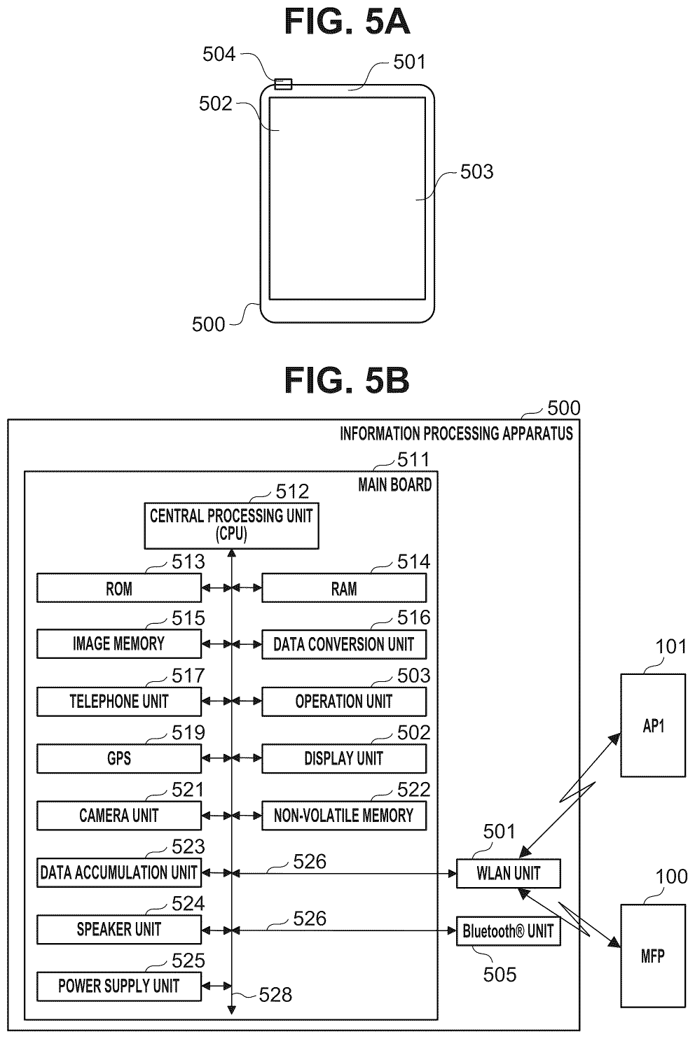

FIG. 5A illustrates an external configuration example of the information processing apparatus 500. In the first exemplary embodiment, the information processing apparatus 500 is a smartphone and includes a display unit 502, an operation unit 503, and a power key 504. The power key 504 is provided as a hardware key for turning on or off the power supply of the information processing apparatus 500. In the first exemplary embodiment, the display unit 502 is a display including an LCD display mechanism. In another exemplary embodiment, the display unit 502 may display information using an LED or the like. The information processing apparatus 500 may include a function for outputting information as voice by attaching the function to the display unit 502 or replacing the display unit 502 with the function. The operation unit 503 may include hardware keys such as keys and buttons, and a touch panel, and may be configured to detect an input of a user operation.

In the first exemplary embodiment, the function of the display unit 502 and the function of the operation unit 503 may be used as a touch panel display. In other words, the display unit 502 and the operation unit 503 may be implemented as a single apparatus. In this case, for example, button icons and a software keyboard are displayed using the function of the display unit 502, and an input of a user operation on the button icons and the software keyboard is detected by the function of the operation unit 503. In another exemplary embodiment, the display unit 502 and the operation unit 503 may be provided as separate hardware modules.

The information processing apparatus 500 may include a WLAN unit 501 configured to provide the WLAN communication function. The WLAN unit 501 is configured to execute, for example, data (packet) communication in a WLAN system compliant with the IEEE 802.11 standard series (IEEE 802.11a/b/g/n/ac/ax/be standards etc.). The WLAN unit 501 may be configured to execute communication in a WLAN system compliant with other standards. The WLAN unit 501 is configured to establish communication frequency bands of 2.4 GHz band, 5 GHz band, and 6 GHz band. As described in detail below, the WLAN unit 501 is configured to execute communication based on Wi-Fi® Direct, communication in the software AP mode, communication in the wireless infrastructure mode, and the like.

### Internal Configuration of Information Processing Apparatus

FIG. 5B illustrates an internal configuration example of the information processing apparatus 500. The information processing apparatus 500 includes a main board 511 that performs main control processing on the information processing apparatus 500, the WLAN unit 501 for establishing WLAN communication, and a Bluetooth® unit 505.

In the first exemplary embodiment, the main board 511 includes a CPU 512, a ROM 513, a RAM 514, an image memory 515, and a data conversion unit 516. The main board 511 further includes a telephone unit 517, a global positioning system (GPS) 519, a camera unit 521, a non-volatile memory 522, a data accumulation unit 523, a speaker unit 524, and a power supply unit 525. The functional units in the main board 511 are interconnected via a system bus 528 and are controlled by the CPU 512. The main board 511 and the WLAN unit 501 are connected via a dedicated bus 526, and the main board 511 and the Bluetooth® unit 505 are also connected via the dedicated bus 526.

The CPU 512 functions as a system control unit for controlling each element of the information processing apparatus 500. The illustrated functions included in the information processing apparatus 500 and processing to be executed by the information processing apparatus 500 are implemented such that the CPU 512 loads programs stored in the ROM 513 into the RAM 514 and executes the programs. More specifically, the ROM 513 stores control programs to be executed by the CPU 512, an embedded OS program, and the like. The CPU 512 executes a corresponding program under the embedded OS, thereby performing software control processing such as scheduling and task switch. The RAM 514 is composed of an SRAM or the like. The RAM 514 stores various data such as variables for controlling programs, setting values registered by the user, and control data for controlling the information processing apparatus 500. The RAM 514 may be used as various work buffers. The image memory 515 is composed of a memory such as a DRAM. The image memory 515 temporarily stores image data received via the WLAN unit 501, and image data read out from the data accumulation unit 523, so that the image data can be processed by the CPU 512. The non-volatile memory 522 is composed of a memory such as a flash memory, and holds the stored data even after the power supply of the information processing apparatus 500 is turned off. The memory configuration of the information processing apparatus 500 is not limited to the above-described example. For example, the image memory 515 and the RAM 514 may be commonly provided, and data backup may be performed using the data accumulation unit 523. In the present exemplary embodiment, a DRAM is used as an example of the image memory 515. Alternatively, any other storage medium such as a hard disk drive (HDD) or a non-volatile memory may be used.

The data conversion unit 516 is configured not only to perform data conversion such as color conversion and image conversion, but also to analyze data in various formats. The telephone unit 517 performs telephone line control processing and processes audio data to be input and output via the speaker unit 524, thereby implementing telephone communication. The GPS 519 receives radio waves transmitted from a satellite and obtains positional information such as the latitude and longitude of the current position of the information processing apparatus 500. The camera unit 521 includes a function for electronically recording and encoding an image input through a lens. Image data obtained by image capturing using the camera unit 521 is stored in the data accumulation unit 523. The speaker unit 524 performs control processing to implement functions of, for example, inputting and outputting audio data for the telephone function and transmitting an alarm notification. The power supply unit 525 includes a battery, and controls supply of power to each element in the information processing apparatus 500. Examples of a power supply state include an out-of-battery state in which the battery remaining amount is less than or equal to a reference value, a power-off state in which the power key 504 is not selected, a power-on state (activated state) in which the power key 504 is selected, and a power-saving state in which the amount of power consumption in each element is suppressed.

The display unit 502 electronically controls a display content, thereby performing control processing to display an operation input from the user, an operation status of the MFP 100, a status, and the like. Upon receipt of an operation input from the user, the operation unit 503 outputs an electric signal corresponding to the input operation to the CPU 512. A touch panel display may be used as the display unit 502 and the operation unit 503 as illustrated in FIG. 5A.

The information processing apparatus 500 is configured to establish wireless communication using the WLAN unit 501, and establishes data communication with another device such as the MFP 100. For example, the information processing apparatus 500 converts data into packets and transmits the packets to another external device. The information processing apparatus 500 receives packets from the other external device via the WLAN unit 501, restores the packets into original data, and outputs the data to the CPU 512.

The configuration of the main board 511 is not limited to the above-described configuration example. For example, each function of the main board 511 implemented by the CPU 512 may be implemented by a processing circuit such as an application-specific integrated circuit (ASIC), or may be implemented by one of hardware and software.

### Wireless Connection Method

Processing for making a wireless access point connection setting for the MFP 100 from the information processing apparatus 500 will now be described. The wireless access point connection setting for the MFP 100 from the information processing apparatus 500 is made using a set-up application to be executed by the information processing apparatus 500. In this set-up application, access point connection information included in the information processing apparatus 500 is transmitted to the MFP 100 by wireless direct communication. The set-up application can also include a function for issuing a print instruction and a scan instruction to the MFP 100. The MFP 100 makes a wireless LAN connection setting using the received access point connection information and connects to the AP to which the information processing apparatus 500 is also connected, thereby making it possible to establish wireless infrastructure mode communication between the information processing apparatus 500 and the MFP 100. The use of the above-described application enables the information processing apparatus 500 to issue an image formation instruction to the MFP 100 by infrastructure communication.

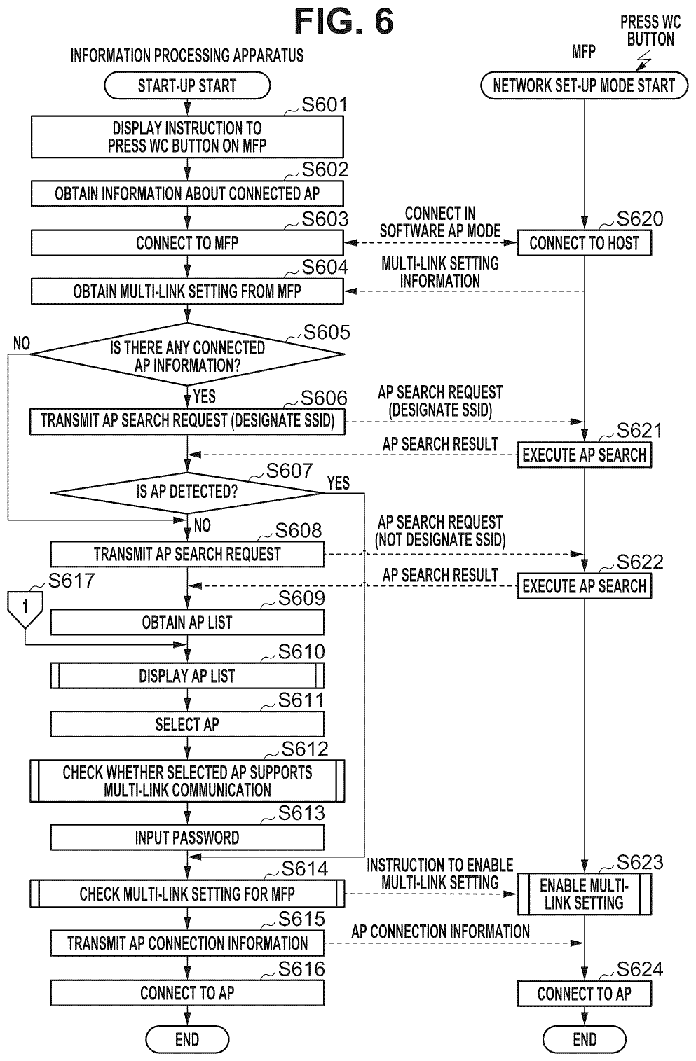

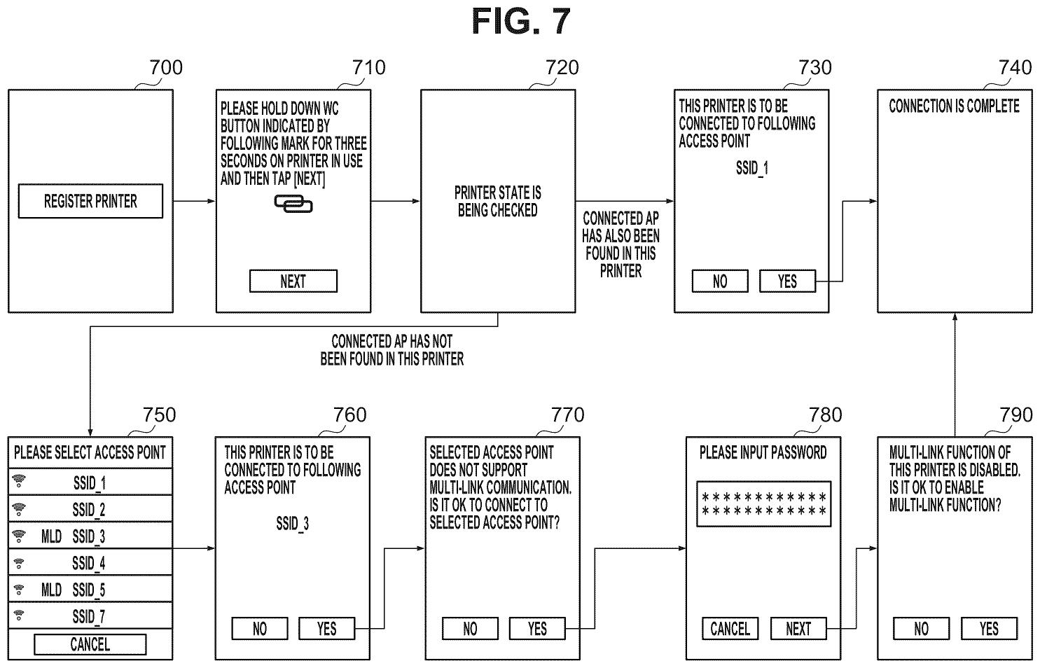

FIG. 6 is a flowchart illustrating processing in the MFP 100 from the information processing apparatus 500 when the wireless access point connection setting for the MFP 100 is made from the information processing apparatus 500. FIG. 7 illustrates a screen display of the information processing apparatus 500 when the wireless connection setting for the MFP 100 is made from the information processing apparatus 500. The MFP 100 is expressed as “printer” in FIG. 7.

The processing illustrated in FIG. 6 is started when the information processing apparatus 500 executes processing of registering the MFP 100 using the set-up application. A screen 700 illustrated in FIG. 7 is a screen to be displayed in this case. When a “register printer” button is selected on the screen 700, in step S601, the information processing apparatus 500 displays an operation guide to start the affiliation with the MFP 100. Specifically, the information processing apparatus 500 displays a screen (e.g., a screen 710 illustrated in FIG. 7) to guide the user to hold down a wireless connect (WC) button for three seconds on the operation unit of the MFP 100. The WC button of the MFP 100 corresponds to the connection setting mode area 303 or the connection setting mode area 310 illustrated in FIGS. 3A to 3C. This operation enables the MFP 100 to transition to a network set-up mode, and the processing flow in the MFP 100 as illustrated in FIG. 6 is started. In the network set-up mode, the MFP 100 starts software AP mode communication to implement a simple access point, and waits for connection from the information processing apparatus 500.

In step S602, if there is an access point to which the information processing apparatus 500 is connected, the information processing apparatus 500 obtains and holds information about the access point. In step S603, the information processing apparatus 500 disconnects the communication with the connected wireless access point and attempts to connect to the access point function in the software AP mode provided by the MFP 100 (e.g., the screen 710 illustrated in FIG. 7). In step S620, when the MFP 100 accepts the connection from the information processing apparatus 500, direct communication between the MFP 100 and the information processing apparatus 500 can be established.

In step S604, the information processing apparatus 500 obtains a multi-link setting from the MFP 100. In step S605, if the connected AP information obtained in step S602 is present (YES in step S605), the processing proceeds to step S606. If the connected AP information is not present (NO in step S605), the processing proceeds to step S608.

In step S606, the information processing apparatus 500 transmits an access point search request to the MFP 100. In this case, the information processing apparatus 500 requests the MFP 100 to search for an access point by designating Service Set Identifier (SSID) information included in the connected AP information obtained in step S602 to check whether the MFP 100 can also be connected to the access point to which the information processing apparatus 500 has been connected. Upon receiving this request, in step S621, the MFP 100 executes an AP search and returns a search result to the information processing apparatus 500. In this case, the MFP 100 also transmits information indicating whether an AP in the search results supports multi-link communication to the information processing apparatus 500. In step S607, the information processing apparatus 500 checks whether the MFP 100 has detected an AP. If the MFP 100 has detected an AP (YES in step S607), the processing proceeds to step S614. If the MFP 100 has not detected any AP (NO in step S607), the processing proceeds to step S608.

In step S608, the information processing apparatus 500 transmits an AP search request to the MFP 100. The information processing apparatus 500 transmits the request for searching for all APs that can be detected by the MFP 100 without designating SSID information. Upon receiving this request, in step S622, the MFP 100 executes an AP search and returns a search result to the information processing apparatus 500. In step S609, the information processing apparatus 500 obtains the AP search result from the MFP 100. This AP search result is referred to as an AP list.

In step S610, the information processing apparatus 500 displays the AP list obtained in step S609. In step S611, the information processing apparatus 500 enables the user to select any one of the APs. A screen 750 illustrated in FIG. 7 is a screen to be displayed in this case on the information processing apparatus 500. A screen 760 is a confirmation screen to be displayed after the user has selected any one of the APs. Display processing will be described in detail below.

In step S612, the information processing apparatus 500 checks whether the AP selected by the user supports multi-link communication, and displays a screen 770 depending on certain conditions. This processing will be described in detail below.

In step S613, the information processing apparatus 500 sends a request for inputting a password for the AP selected by the user in step S611 (e.g., a screen 780). In step S614, the information processing apparatus 500 checks the state of the multi-link setting for the MFP 100, and displays a screen 790 depending on certain conditions. If “YES” is selected on the screen 790, the information processing apparatus 500 issues an instruction to enable the multi-link setting to the MFP 100. Upon receiving this instruction, in step S623, the MFP 100 makes a setting for enabling the multi-link setting.

In step S615, the information processing apparatus 500 transmits AP connection information for the MFP 100 to connect to the AP. In step S624, the MFP 100 that has received the AP connection information connects to the AP. If the AP is detected in step S607, this AP connection information corresponds to the SSID and the password for the AP obtained in step S602 by the information processing apparatus 500. In step S607, if the AP is not detected or if the AP information obtained in step S602 is not present, in step S611, the SSID for the AP selected by the user in step S611 and the password input in step S613 are obtained.

In step S616, the information processing apparatus 500 also connects to the AP to which the MFP 100 is instructed to connect, and displays a screen 740 to complete set-up processing. As described above, the information processing apparatus 500 and the MFP 100 establish wireless infrastructure communication via the AP.

### Display of AP List

Display of the AP list described above in step S610 illustrated in FIG. 6 will be described in detail.

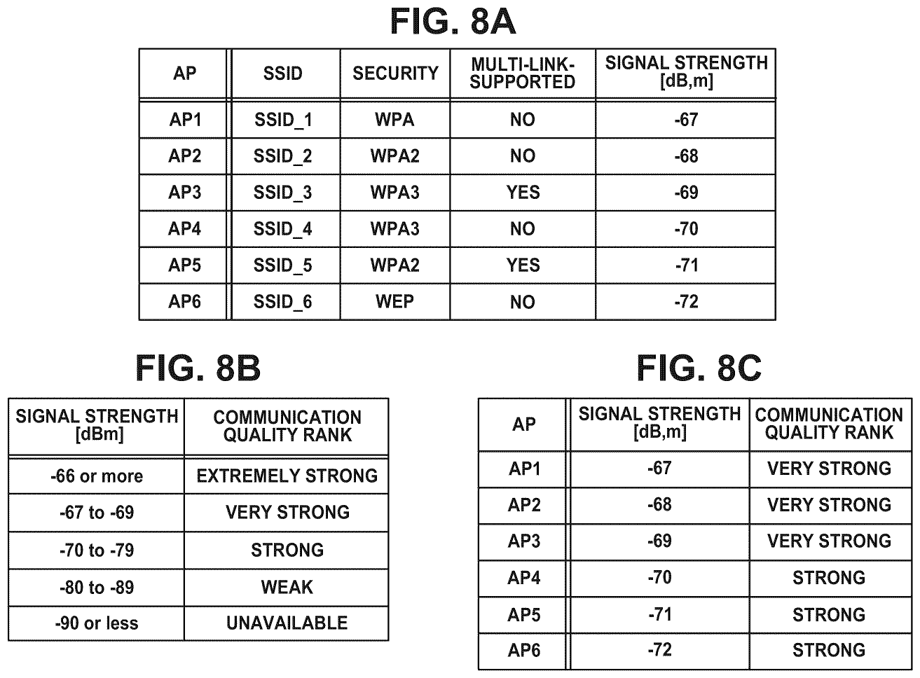

FIGS. 8A to 8C are tables each illustrating AP attribute information about an AP group according to the first exemplary embodiment.

FIG. 8A is a table illustrating an AP list that includes information obtained such that the MFP 100 searches for APs in the vicinity of the MFP 100 in step S623 illustrated in FIG. 6 and is obtained by the information processing apparatus 600 from the MFP 100 in step S609. An “AP” row in the table indicates an AP number for the following description. Assume that the MFP 100 has found six APs, i.e., AP 1 to AP 6, as a result of executing the AP search, and has obtained the pieces of information from beacon signals from the APs. An “SSID” row indicates an identifier for each AP. A “security” row indicates a security setting for each AP. Types of the security setting include WEP, WPA, WPA2, and WPA3.

The security strength of WPA3 is the highest. The security strength of WPA2 is higher than the security strength of WPA. The security strength of WEP is the lowest. A “multi-link-supported” row indicates whether the AP supports the multi-link communication function. In the table, “YES” indicates that the AP supports the multi-link communication function, and “NO” indicates that the AP does not support the multi-link communication function. A determination whether the AP supports the multi-link communication function is made based on, for example, a basic multi-link element, reduced neighbor report element, or the like included in the beacon and probe frames transmitted from the AP. While the present exemplary embodiment illustrates a configuration for determining whether each AP supports the multi-link communication function, the present exemplary embodiment is not limited to this example. For example, a configuration for determining whether each AP supports the IEEE 802.11be or later standard may be employed. Information indicating whether the AP supports the IEEE 802.11be or later standard may be included in the AP attribute information. A “signal strength” row indicates the strength of a radio signal that reaches the MFP 100 from each AP. The unit of the signal strength is decibels relative to milliwatt (dBm), and the signal strength decreases as the value decreases. Specifically, from among the APs in the table, the signal strength of the AP 1 is the highest and the signal strength of the AP 6 is the lowest. In steps S621 and S622, the MFP 100 searches for APs in the vicinity of the MFP 100 to obtain AP attribute information illustrated in FIG. 8A, and transmits the AP attribute information to the information processing apparatus 500. Specifically, the MFP 100 transmits the information including information obtained by AP search and information indicating whether the AP supports multi-link communication to the information processing apparatus 500. The configuration of the MFP 100 is not limited to this example. For example, the MFP 100 may transmit only the SSID of the AP that can be detected by searching for APs in the vicinity of the MFP 100 to the information processing apparatus 500 in step S622. The information processing apparatus 500 may be configured to obtain AP attribute information illustrated in FIG. 8A based on the AP attribute information obtained by searching for APs in the vicinity of the information processing apparatus 500 and the SSID transmitted from the MFP 100.

FIG. 8B is a correspondence table illustrating signal strengths and communication quality ranks. Each communication quality rank is associated with a signal strength range depending on the reliability and desirability of communication. In general, a desirable signal strength varies depending on the intended use or application of a communication apparatus to be used. Accordingly, this correspondence table is merely an example. In the MFP 100, the communication quality rank corresponding to a signal strength of −66 dBm or more is expressed as “extremely strong”. The communication quality rank corresponding to a signal strength in a range from −67 dBm to −69 dBm is expressed as “very strong”. The communication quality rank corresponding to a signal strength in a range from −70 dBm to −79 dBm is expressed as “strong”. The communication quality rank corresponding to a signal strength in a range from −80 dBm to −89 dBm is expressed as “weak”. The communication quality rank corresponding to a signal strength of −90 dBm or less is expressed as “unavailable”. The information indicated by the table is stored in the information processing apparatus 500, but can also be stored in the MFP 100.

FIG. 8C is a table illustrating the communication quality rank for each AP. The information processing apparatus 500 or the MFP 100 determines the communication quality rank of each AP based on the signal strength of each AP illustrated in FIG. 8A and the correspondence table illustrating the signal strengths and the communication quality ranks illustrated in FIG. 8B. The signal strength of each of the AP 1, the AP 2, and the AP 3 falls within the range from −67 dBm to −69 dBm illustrated in FIG. 8B. Accordingly, the MFP 100 determines the communication quality rank of each of the AP 1, the AP 2, and the AP 3 to be “very strong”. The signal strength of each of the AP 4, the AP 5, and the AP 6 falls within the range from −70 dBm to −79 dBm illustrated in FIG. 8B. Accordingly, the MFP 100 determines the communication quality rank of each of the AP 4, the AP 5, and the AP 6 to be “strong”.

Display control processing for controlling display of the result of AP search executed by the information processing apparatus 500 according to the first exemplary embodiment will now be described.

### Display Control Processing of Mobile Terminal Apparatus

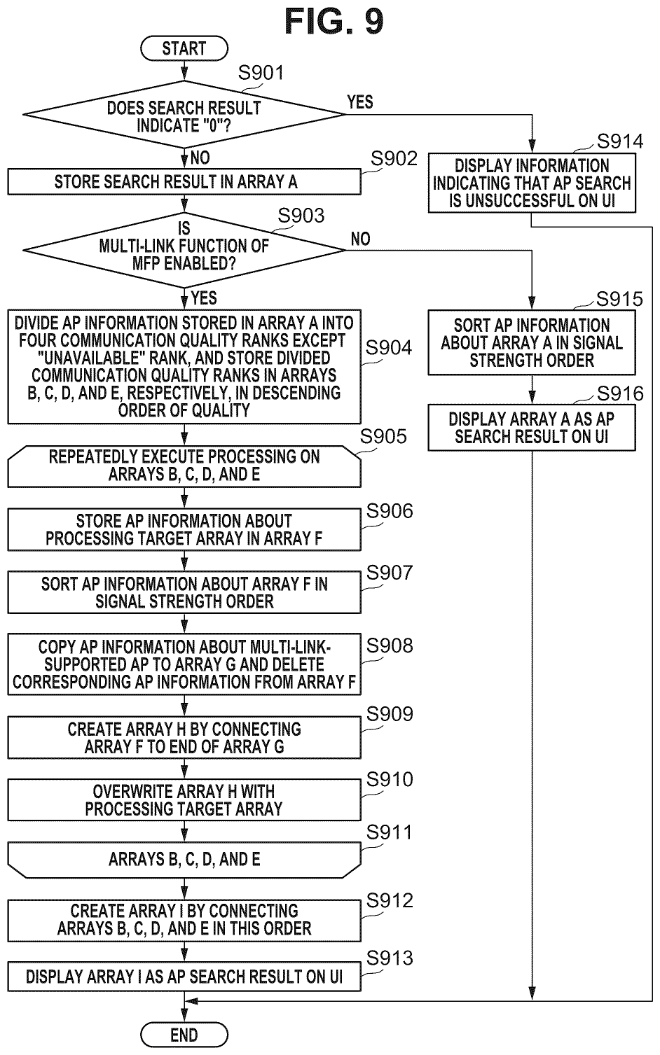

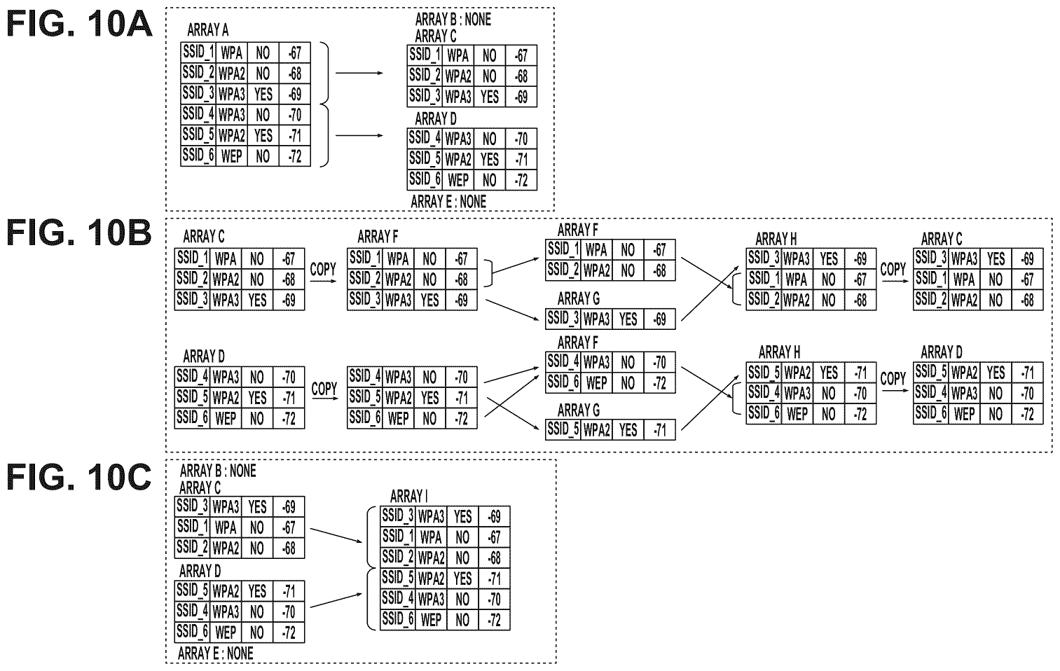

FIG. 9 is a flowchart illustrating a flow of AP display control processing in the information processing apparatus 500 according to the first exemplary embodiment. FIGS. 10A to 10C each illustrate array data handled in display control processing according to the first exemplary embodiment.

The flowchart illustrated in FIG. 9 is a detailed processing flow of step S610 illustrated in FIG. 6, and is implemented such that the CPU 512 reads out programs stored in the ROM 513 into the RAM 514 and executes the programs.

In step S901, the CPU 512 determines whether the AP search executed by the MFP 100 is successful.

If there is no AP to which the beacon signal is transmitted within the search range of the MFP 100, the AP search result obtained from the MFP 100 indicates “0” (YES in step S901), the processing proceeds to step S914. In step S914, the CPU 512 displays information indicating that the AP search is unsuccessful to the operation display control unit 220. After that, the processing ends.

If the CPU 512 determines that the AP search executed by the MFP 100 is successful (YES in step S901), the processing proceeds to step S902. In step S902, the CPU 512 stores the AP attribute information about the AP group searched by the MFP 100 in an array A stored in the RAM 514. FIG. 10A illustrates an image of the array A.

In step S903, the CPU 512 reads out multi-link setting information about the MFP 100 from the RAM 514, and determines whether the multi-link communication function of the MFP 100 is enabled. If the CPU 512 determines that the multi-link communication function is not enabled (NO in step S903), the processing proceeds to step S915.

In step S915, the CPU 512 executes processing of sorting the AP group stored in the array A in descending order of signal strength. For example, bubble sort is used in this processing. In step S916, the CPU 512 displays the array A as the AP search result on a user interface (UI). Then, the processing ends.

In step S903, if the CPU 512 determines that the multi-link communication function is enabled (YES in step S903), the processing proceeds to step S904. In step S904, AP search results are sorted using multi-link-supported information included in the AP information.

In step S904, the AP information stored in the array A is divided into four communication quality ranks except the “unavailable” rank, and the communication quality ranks are stored in arrays B, C, D, and E, respectively, in descending order of quality. Specifically, the array B stores AP information indicating that the quality rank is “extremely strong”, the array C stores AP information indicating that the quality rank is “very strong”, the array D stores AP information indicating that the quality rank is “strong”, and the array E stores AP information indicating that the quality rank is “weak”. The AP information about the six APs illustrated in the present exemplary embodiment includes only information about the APs with the quality ranks of “very strong” and “strong” as illustrated in FIG. 8C. Accordingly, data is stored only in the array C and the array D. FIG. 10A illustrates images of the arrays A, C, and D.

In step S905, the CPU 512 repeatedly executes processing of steps S906 to S910 on each of the arrays B, C, D, and E. However, as described above, data is stored only in the array C and the array D as the AP information about the six APs illustrated in the present exemplary embodiment. Accordingly, the processing of steps S906 to S910 is not substantially performed on the array B and the array E.

In step S906, AP information about the array on which the processing is repeatedly performed this time is stored in an array F. In step S907, AP information about the array F is sorted in descending order of signal strength (already sorted in descending order of signal strength in this example). For example, bubble sort is used also in this processing. In step S908, AP information about multi-link-supported APs in the AP information included in the array F is copied to an array G, and the corresponding AP information is deleted from the array F. In step S909, the CPU 512 creates an array H by connecting the array F to the end of the array G. In step 910, the original array, or the array on which the processing is repeatedly performed this time, is overwritten with the array H. As described above, the sorting processing on the APs for one quality rank is completed. Then, the CPU 512 repeatedly performs the processing of steps S906 to S910 on the arrays for the other quality ranks. FIG. 10B illustrates images of the arrays C, D, E, F, G, and H as described above. After completion of the processing on all arrays, the processing proceeds to step S912.

In step S912, the CPU 512 creates an array I by connecting the arrays B, C, D, and E in this order.

FIG. 10C illustrates images of the arrays C, D, and I described above. The CPU 512 displays the array I as the AP search result on the UI. Then, the processing ends.

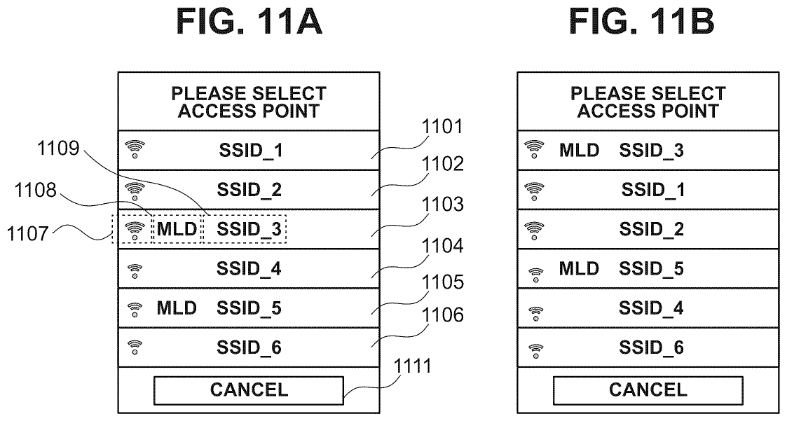

FIGS. 11A and 11B each illustrate an AP selection screen on which an AP search result is displayed on the information processing apparatus 500.

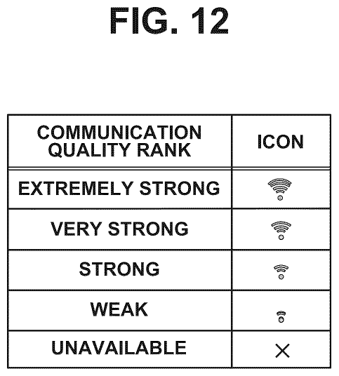

FIG. 12 is a correspondence table illustrating icons to be displayed and radio wave quality ranks.

FIG. 11A illustrates an AP selection screen for the operation display control unit 220 when the multi-link setting for the MFP 100 is disabled. This screen corresponds to a screen displayed in step S915 illustrated in FIG. 9. Areas 1101 to 1106 are AP information areas for the APs, respectively, and one row is displayed for each AP. The configuration of an AP information area will be described using the area 1103. An area 1107 is a radio wave icon area indicating a radio wave quality rank. FIG. 12 illustrates a correspondence table illustrating radio wave icons to be displayed and radio wave quality ranks. An area 1108 is a multi-link-supported information area indicating whether the AP supports the multi-link communication function. If the AP supports the multi-link communication function, “MLD” is displayed in the area 1108. An SSID area 1109 indicates identification information about the AP. A cancel button 1111 is used to cancel selection of the AP. FIG. 11A illustrates “SSID_1”, “SSID_2”, “SSID_3”, “SSID_4”, “SSID_5”, and “SSID_6” in this order from the top as SSID information in AP information. This order corresponds to the order of the AP 1, the AP 2, the AP 3, the AP 4, the AP 5, and the AP 6 in the “AP” row illustrated in FIG. 8A, that is, the APs are sorted in descending order of signal strength. If the APs have the same signal strength, the APs are sorted in the order of detection.

FIG. 11B illustrates an AP selection screen for the operation display control unit 220 when the multi-link setting for the MFP 100 is enabled. This screen corresponds to the screen displayed in step S913 illustrated in FIG. 9.

A configuration within the screen is similar to that illustrated in FIG. 11A. FIG. 11B illustrates “SSID_3”, “SSID_1”, “SSID_2”, “SSID_5”, “SSID_4”, and “SSID_6” in this order from the top as SSID information in AP information. This order corresponds to the order of the AP 3, the AP 1, the AP 2, the AP 5, the AP 4, and the AP 6 in the “AP” row illustrated in FIG. 8A. From among the AP 1, the AP 2, and the AP 3, each of which belongs to the communication quality rank “very strong”, the AP 3 that supports the multi-link communication function is displayed at the top. From among the AP 4, the AP 5, and the AP 6, each of which belongs to the communication quality rank “strong”, the AP 5 that supports the multi-link communication function is displayed at the top.

The display as described above makes it possible to clearly indicate APs that support the multi-link communication function from among the adjacent displayed APs with the same communication quality, and to display the multi-link-supported APs with higher priority than multi-link-not-supported APs. From among the multi-link-supported APs, the multi-link-supported AP with the highest communication quality rank is displayed at the top of the AP search result screen. This configuration enables the user to search for the AP with the highest communication quality from the A search result if there are many APs in proximity.

### Confirmation as to Whether AP Supports Multi-Link Communication Function

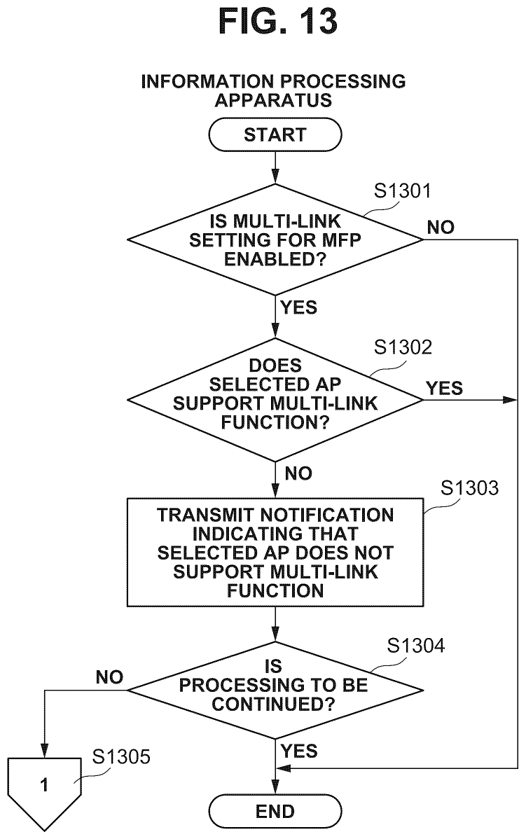

FIG. 13 is a flowchart illustrating a flow of display control processing to be performed by the information processing apparatus 500 according to the first exemplary embodiment. The flowchart illustrated in FIG. 9 is a detailed processing flow of step S612 illustrated in FIG. 6.

In step S1301, the CPU 512 determines whether the multi-link setting for the MFP 100 is enabled. If the multi-link setting for the MFP 100 is enabled (YES in step S1301), the processing proceeds to step S1302. If the multi-link setting for the MFP 100 is not enabled (NO in step S1301), the processing ends.

In step S1302, the CPU 512 determines whether the AP selected by the user in step S611 supports the multi-link communication function. If the AP does not support the multi-link communication function (NO in step S1302), the processing proceeds to step S1303. If the AP supports the multi-link communication function (YES in step S1302), the processing ends.

In step S1303, the CPU 512 transmits a notification indicating that the AP selected by the user does not support the multi-link communication function to the user. The screen 770 illustrated in FIG. 7 is an example of the screen displayed in this case. If the “YES” button is selected on the screen 770, in step S1304, it is determined that the processing is to be continued (YES in step S1304), and then the processing ends. If the “NO” button is selected on the screen 770 (NO in step S1304), the processing proceeds to step S1305. The processing of step S1305 leads to step S617 illustrated in step S617. In step S610, the user can select another AP. As described above, if the user accidentally selects the AP that does not support the multi-link communication function, the user can select another AP.

### Confirmation as to Whether AP Supports Multi-Link Communication Function

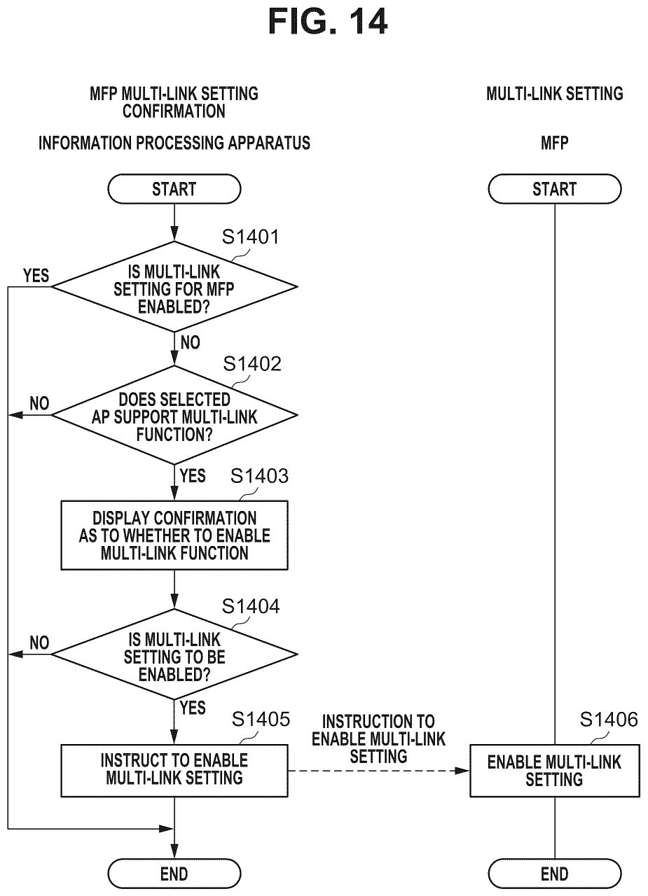

FIG. 14 is a flowchart illustrating a flow of display control processing to be performed by the information processing apparatus 500 according to the first exemplary embodiment. This processing is a detail processing flow of steps S614 and S623 illustrated in FIG. 6.

In step S1401, the CPU 512 determines whether the multi-link setting for the MFP 100 is enabled. If the multi-link setting for the MFP 100 is not enabled (NO in step S1401), the processing proceeds to step S1402. If the multi-link setting for the MFP 100 is enabled (YES in step S1401), the processing ends.

In step $1402, the CPU 512 determines whether the AP selected by the user in step S611 supports the multi-link communication function. If the AP supports the multi- link communication function (YES in step S1402), the processing proceeds to step S1403. If the AP does not support the multi-link communication function (NO in step S1402), the processing ends.

In step S1403, the CPU 512 confirms whether the user intends to enable the multi-link setting for the AP selected by the user. The screen 790 illustrated in FIG. 7 is an example of the display screen displayed in this case. If the “YES” button is selected on the screen 790 (YES in step S1404), the processing proceeds to step S1405. In step S1405, the CPU 512 transmits an instruction to enable the multi-link setting to the MFP 100. Upon receiving this instruction, in step S1406, the MFP 100 enables the multi-link setting. As described above, if the AP selected on the information processing apparatus 500 supports the multi-link communication function, the user can change the multi-link communication function setting for the MFP 100 from the information processing apparatus 500.

While the first exemplary embodiment illustrates an example where the MFP 100 executes an AP search, a second exemplary embodiment illustrates an example where the information processing apparatus 500 executes an AP search.

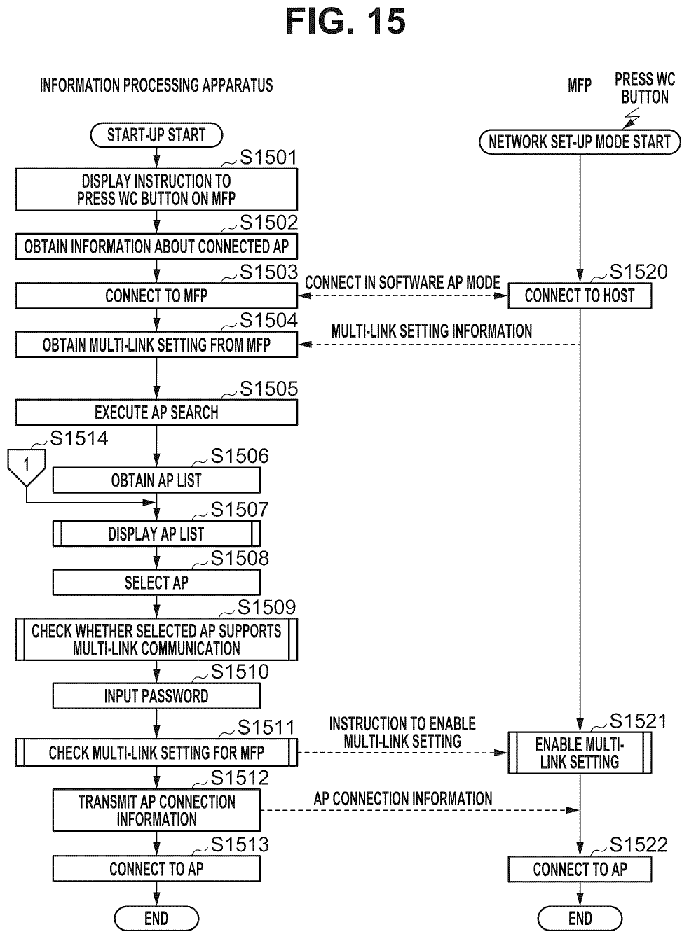

FIG. 15 is a flowchart illustrating processing to be performed by the information processing apparatus 500 and the MFP 100 to make a wireless access point connection setting for the MFP 100 from the information processing apparatus 500 according to the second exemplary embodiment.

A basic configuration of this flowchart is similar to that illustrated in FIG. 6. The flowchart according to the second exemplary embodiment differs from the flowchart of FIG. 6 in that an AP search is not executed by the MFP 100, but is executed by the information processing apparatus 500.

Steps S1501 to S1504 in the processing to be performed by the information processing apparatus 500 are respectively identical to steps S601 to S604 illustrated in FIG. 6. In step S1505, the information processing apparatus 500 executes an AP search.

In step S1506, the information processing apparatus 500 obtains a search result as an AP list. The information processing apparatus 500 obtains AP attribute information as illustrated in FIG. 8A. After that, steps S1507 to S1513 are respectively identical to steps S610 to S616 illustrated in FIG. 6.

In the processing to be performed by the MFP 100, steps S1501 to S1520 are respectively identical to steps S601 to S620 illustrated in FIG. 6. The AP search executed by the MFP 100 in steps S621 and S622 illustrated in FIG. 6 is not executed. After that, steps S1521 and S1522 are respectively identical to steps S623 and S624 illustrated in FIG. 6.

In the processing of this flowchart, the AP search is executed by the information processing apparatus 500, so that no processing load is imposed on the MFP 100. In the case of displaying the AP search result on the information processing apparatus 500, multi-link-supported APs are preferentially displayed, which facilitates the user to select an appropriate AP. AP attribute information as illustrated in FIG. 8A, which is obtained such that the information processing apparatus 500 searches for APs, may be transmitted to the MFP 100. The MFP 100 that has received the AP attribute information may display an AP list and the user may select the AP to be connected.

According to the first and second exemplary embodiments, from among the APs with the same communication quality in the AP list, multi-link-supported APs are displayed with higher priority than multi-link-not-supported APs. However, the method of determining the display order using multi-link-supported information is not limited to the above-described method. A third exemplary embodiment illustrates an example where multi-link-supported APs and multi-link-not-supported APs are displayed in descending order of communication quality.

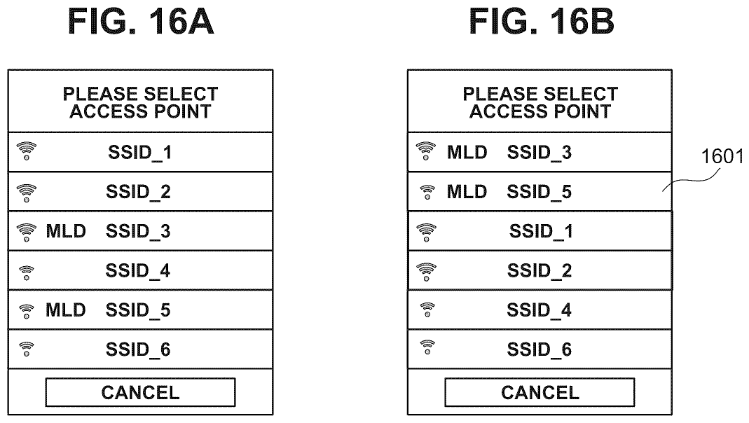

FIGS. 16A and 16B each illustrate an AP selection screen for the information processing apparatus 500 according to the third exemplary embodiment.

The configuration of the AP selection screen is similar to that illustrated in FIGS. 11A and 11B according to the first exemplary embodiment. AP information about each AP is the same as that illustrated in FIGS. 8A to 8C according to the first exemplary embodiment. The correspondence between radio wave icons to be displayed and radio wave quality ranks is also the same as that illustrated in FIG. 12 according to the first exemplary embodiment.

FIG. 16A illustrates an AP selection screen for the operation display control unit 220 when the multi-link setting for the MFP 100 is disabled. This screen is the same as the screen illustrated in FIG. 11A in the first exemplary embodiment.

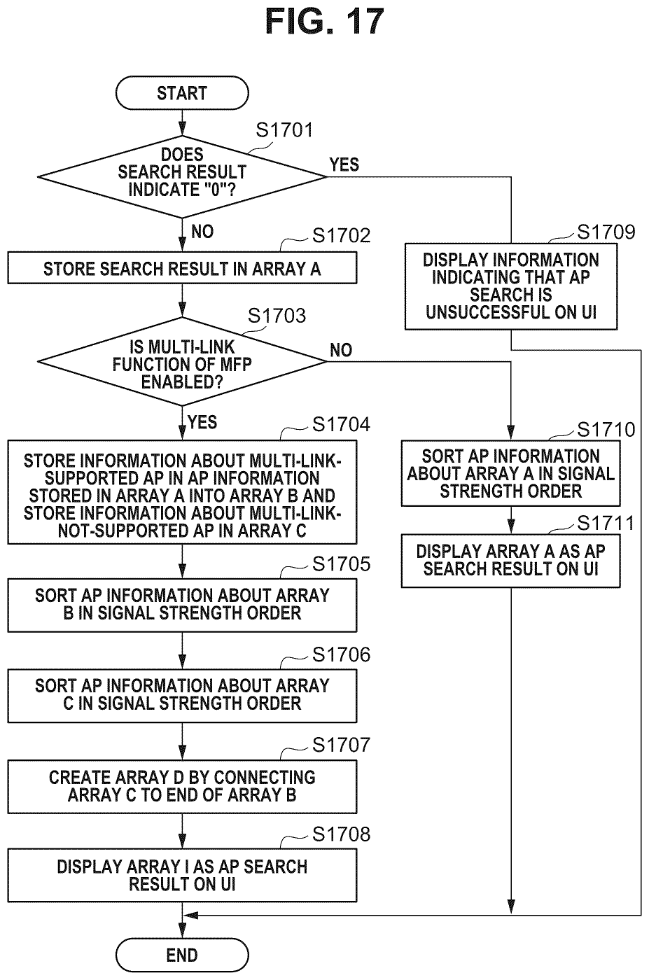

FIG. 16B illustrates an AP selection screen for the operation display control unit 220 when the multi-link setting for the MFP 100 is enabled. FIG. 16B differs from FIG. 11B in that a row 1601 indicating “SSID_5” is displayed in the second row from the top. FIG. 17B illustrates “SSID_3”, “SSID_5”, “SSID_1”, “SSID_2”, “SSID_4”, and “SSID_6” in this order from the top as SSID information in AP information. This order corresponds to the order of the AP 3, the AP 5, the AP 1, the AP 2, the AP 4, and the AP 6 in the AP attribute information illustrated in FIG. 8A. The AP 3 and the AP 5, which are multi-link-supported APs, are displayed above the AP 1, the AP 2, the AP 4, and the AP 6, which are multi-link-not-supported APs. From among the multi-link-supported APs, the AP 3 with the higher radio wave quality rank is displayed above the AP 5. From among the multi-link-not-supported APs, the AP 1 and the AP 2 with the higher radio wave quality rank are displayed above the AP 4 and the AP 6. The AP 1 and the AP 2 having the same radio wave quality rank are displayed in this order, that is, in descending order of signal strength. The AP 4 and the AP 6 having the same radio wave quality rank are displayed in this order, that is, in descending order of signal strength.

FIG. 17 is a flowchart illustrating a flow of display control processing to be performed by the information processing apparatus 500 according to the third exemplary embodiment. A basic configuration of this flowchart is similar to that illustrated in FIG. 9, and thus only differences will be described.

In step S1701, the CPU 512 determines whether the AP search executed by the MFP 100 is successful. If there is no AP to which the beacon signal is transmitted in the vicinity, the AP search result obtained from the MFP 100 indicates “0” (YES in step S1701), and the processing proceeds to step S1709. In step S1709, the CPU 512 displays information indicating that the AP search is unsuccessful to the operation display control unit 220. After that, the processing ends. If the CPU 512 determines that the AP search is successful (NO in step S1701), the processing proceeds to step S1702. In step S1702, the CPU 512 stores AP information about the searched AP group in the array A illustrated in FIG. 10 that is stored in the RAM 514.

In step S1703, the CPU 512 reads out information about the multi-link setting for the MFP 100 from the RAM 514, and determines whether the multi-link communication function for the MFP 100 is enabled. If the CPU 512 determines that the multi-link communication function is not enabled (NO in step S1703), the processing proceeds to step S1710. Steps S1710 and S1711 are respectively identical to steps S915 and S916 illustrated in FIG. 9 according to the first exemplary embodiment, and thus descriptions thereof are omitted.

If the CPU 512 determines that the multi-link communication function is enabled (YES in step S1703), the processing proceeds to step S1704. In step S1704, AP search results are sorted using the multi-link-supported information included in the AP information. In step S1704, information about multi-link-supported APs in the AP information stored in the array A is stored in the array B and information about multi-link-not-supported APs in the AP information is stored in the array C. In step S1705, the AP information about the array B is sorted in descending order of signal strength. In step S1706, the AP information about the array C is sorted in descending order of signal strength. In step S1707, the CPU 512 creates the array D by connecting the array C to the end of the array B. In step S1708, the CPU 512 displays the array I as the AP search result on the UI. Then, the processing ends.

The processing of this flowchart enables the user to recognize multi-link-supported APs at a glance so that the user can easily select an appropriate AP.

### Other Embodiments

The exemplary embodiments described above illustrate an example where multi-link-supported APs are preferentially displayed in processing of making a wireless access point connection setting for the MFP 100 from the information processing apparatus 500. However, the configuration according to the exemplary embodiments is not limited to this example. For example, in a case where the information processing apparatus 500 searches for APs to which the information processing apparatus 500 is connected, the information processing apparatus 500 may preferentially display multi-link-supported APs.

While the exemplary embodiments described above illustrate an example where the MFP 100 and the information processing apparatus 500 perform various control processing, the above-described various control processing may be performed by only one piece of hardware, or the overall control processing of the information processing apparatus 500 may be shared by a plurality of pieces of hardware (e.g., a plurality of processors or circuits).

The present disclosure has been described in detail above based on exemplary embodiments. However, the present disclosure is not limited to these specific exemplary embodiments, and various forms within the scope of the present disclosure are also included in the present disclosure. The above-described exemplary embodiments are merely embodiments of the present disclosure, and the exemplary embodiments may be combined as appropriate.

While the above-described exemplary embodiments illustrate an example where the present disclosure is applied to the MFP 100 and the information processing apparatus 500, the present disclosure is not limited to this example. The present disclosure can be applied to any wireless devices. Specifically, the present disclosure can be applied to a PC, a PDA, a tablet terminal, a mobile phone terminal, such as a smartphone, a music player, a game console, an electronic book reader, a smartwatch, and various measurement devices (sensor devices), such as a thermometer and a hydrometer. The present disclosure can also be applied to a digital camera (including a still camera, a video camera, a network camera, and a security camera), a printer, a scanner, and a drone. The present disclosure can also be applied to a video output apparatus, an audio output apparatus (e.g., a smart speaker), a media streaming player, and a wireless LAN cordless handset (adaptor) connectable to a USB terminal or a LAN cable terminal. Examples of the video output apparatus include an apparatus configured to obtain (download) a moving image on the Internet that is specified by a Uniform Resource Locator (URL) instructed from an electronic apparatus and output the video image on a display apparatus connected via a video output terminal of a high-definition multimedia interface (HDMI®) or the like, thereby implementing streaming on the display apparatus, or implementing mirroring display (causing the display apparatus to display a content displayed on the electronic apparatus). Examples of the video output apparatus also include a television set, a media player, such as a hard disk recorder, a Blu-ray recorder, and a digital versatile disc (DVD) recorder, a head-mounted display, a projector, a display apparatus (monitor), and a signage apparatus. The present disclosure can also be applied to so-called smart appliances that can be connected via Wi-Fi®, such as an air conditioner, a refrigerator, a washing machine, a cleaner, an oven, a microwave oven, lighting equipment, heating equipment, and cooling equipment.

The present disclosure can also be implemented by processing in which a program for implementing one or more functions according to the above-described exemplary embodiments is supplied to a system or an apparatus via a network or a storage medium, and one or more processors in a computer of the system or the apparatus read out and execute the program. The present disclosure can also be implemented by a circuit (e.g., an ASIC) for implementing one or more functions according to the exemplary embodiments.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-016992, filed Feb. 7, 2024, which is hereby incorporated by reference herein in its entirety.

What is claimed is:

1. An information processing apparatus configured to communicate with an external apparatus, the information processing apparatus comprising:
a memory storing a program;
a processor, that when executing the program, causes the information processing apparatus to:
search for an external access point;
obtain information indicating whether the access point found by the search supports multi-link communication; and
transmit information about the access point found by the search to the external apparatus,
wherein the transmitted information includes the obtained information indicating whether the access point supports multi-link communication.

2. The information processing apparatus according to claim 1, wherein the processor causes the information processing apparatus to receive, from the external apparatus, connection information about an access point selected by a user from a list of access points displayed on the external apparatus based on the transmitted information about the access point.

3. The information processing apparatus according to claim 2, wherein the processor causes the information processing apparatus to connect to an access point using the received connection information.

4. The information processing apparatus according to claim 2, wherein information about an access point that supports multi-link communication in the list is displayed with higher priority than information about an access point that does not support multi-link communication in the list.

5. The information processing apparatus according to claim 2, wherein an access point that supports multi-link communication in the list is displayed together with information indicating that the access point supports multi-link communication.

6. The information processing apparatus according to claim 1, wherein the processor causes the information processing apparatus to make a setting whether to enable a multi-link communication function of the information processing apparatus.

7. The information processing apparatus according to claim 6, wherein the processor causes the information processing apparatus to, upon receipt of an instruction to enable the multi-link communication function of the information processing apparatus from the external apparatus, enable the multi-link communication function.

8. The information processing apparatus according to claim 1,
wherein the processor causes the information apparatus to, upon receipt of an access point search request from the external apparatus, search for an external access point, and
wherein information about the access point to the external apparatus is transmitted as a response to the search request.

9. An information processing apparatus configured to communicate with an external apparatus, the information processing apparatus comprising:
a reception unit configured to receive information about an access point searched by the external apparatus from the external apparatus; and
a memory storing a program and a processor, that when executing the program, causes the information processing apparatus to display the received information about the access point,
wherein the received information includes information indicating whether the access point supports multi-link communication, and
wherein information about an access point that supports multi-link communication is displayed with higher priority than information about an access point that does not support multi-link communication.

10. The information processing apparatus according to claim 9, wherein the processor causes the information processing apparatus to display an access point that supports multi-link communication together with information indicating that the access point supports multi-link communication.

11. A method executed by an information processing apparatus configured to communicate with an external apparatus, the method comprising:
searching for an external access point;
obtaining information indicating whether the access point found by the search supports multi-link communication; and
transmitting information about the access point found by the search to the external apparatus,
wherein the transmitted information includes the obtained information indicating whether the access point supports multi-link communication.

12. The method according to claim 11, further comprising receiving, from the external apparatus, connection information about an access point selected by a user from a list of access points displayed on the external apparatus based on the transmitted information about the access point.

13. The method according to claim 12, further comprising connecting to an access point using the received connection information.

14. The method according to claim 12, wherein information about an access point that supports multi-link communication in the list is displayed with higher priority than information about an access point that does not support multi-link communication in the list.

15. The method according to claim 12, wherein an access point that supports multi-link communication in the list is displayed together with information indicating that the access point supports multi-link communication.

16. The method according to claim 11, wherein a setting whether to enable a multi-link communication function of the information processing apparatus is made.

17. The method according to claim 16, wherein, upon receipt of an instruction to enable the multi-link communication function of the information processing apparatus from the external apparatus, the multi-link communication function is enabled.

18. The method according to claim 11,
wherein, upon receipt of an access point search request from the external apparatus, search for an external access point is performed, and
wherein information about the access point to the external apparatus is transmitted as a response to the search request.
